(19) United States
(12) Patent Application Publication
(10) Pub. No.: US 2024/0341330 A1
(43) Pub. Date: Oct. 17, 2024

(54) HANDHELD VACUUM MARINATOR DEVICE

(71) Applicant: Sunbeam Products, Inc., Atlanta, GA (US)

(72) Inventor: Zak Hartman, Parkland, FL (US)

(21) Appl. No.: 18/681,903

(22) PCT Filed: Aug. 23, 2022
(86) PCT No.: PCT/US2022/075310

§ 371 Date: Feb. 7, 2024

Related U.S. Application Data
(60) Provisional application No. 63/235,981, filed on Aug. 23, 2021.

(51) Int. Cl. A23L 3/00; A23L 3/015; A23L 13/75; A23L 13/76; A47J 43/00; B65B 25/00; B65B 31/04

(52) U.S. Cl. CPC A23L 3/001; A23L 3/0155; A23L 13/75; A23L 13/76; A47J 43/00; B65B 25/001; B65B 31/042

(57) ABSTRACT

A handheld vacuum marinator device is provided. The device can include a suction function button configured to activate a suction procedure when depressed and a marinade function button configured to activate a marinade procedure when depressed. The suction procedure includes activating a vacuum device to pull a vacuum through a suction inlet and deactivating the vacuum device when a first vacuum level is detected, and the marinade procedure includes initiating a plurality of cycles of activating the vacuum device to pull the vacuum through the suction inlet, deactivating the vacuum device when a second vacuum level is detected, holding the second vacuum level for a first preset amount of time, releasing the vacuum after the first preset amount of time, and waiting a second preset amount of time to reactivate the vacuum device for a start of a next one of the plurality of cycles.

### CROSS-REFERENCE TO RELATED APPLICATIONS

This Application claims priority to U.S. Provisional Patent Application Ser. No. 63/235,981, filed on Aug. 23, 2021, entitled “HANDHELD VACUUM MARINATOR DEVICE,” currently pending, the entire disclosure of which is incorporated herein by reference.

### FIELD OF INVENTION

The present invention relates generally to food marinating. More particularly, it relates to a handheld cordless vacuum device for marinating food contained in storage containers and/or bags.

### BACKGROUND OF THE INVENTION

Vacuum sealing technology has revolutionized the food industry. Manual and electric vacuum sealers have enabled home users to prepare, store, preserve, and cook food products in new and innovative ways. One innovative food preparation method enabled by such technology includes vacuum marinating a food product. Traditionally, marinating a food product includes a lengthy time process where the food product is left to sit for several hours or even several days in a vessel or bag surrounded by a marinade. Over time, the marinade penetrates into the food product to impart additional tenderness and flavor to the food product. Vacuum marination drastically decreases the time frame for marination by employing recurring cycles of vacuum pressure and release to the marinating food product. Known vacuum marination methods employ accessory valves on large bulky vacuum sealing machines, small manual hand pumps that are difficult to use and do not pull a consistent vacuum level, or large commercial vacuum tumblers used to both marinate and tenderize the food product.

In light of the forgoing there is a continuing need for a handheld electric vacuum marination device.

### SUMMARY OF THE INVENTION

Provided herein is a handheld vacuum marination system that can be charged as needed in a charging cradle. The vacuum marination system includes a housing with a suction inlet and a with a removable reservoir. In use, the suction inlet can be coupled to a vacuum container containing a food product and marinade.

The housing may include a suction function button to activate a suction procedure and a marinade function button to activate a marinade procedure. The suction procedure may include activating a vacuum device contained within the housing to pull the vacuum through the suction inlet and any bag or container attached thereto. The marinade procedure can include automatically initiating a plurality of cycles activating, holding, and releasing the vacuum.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a front elevation view of a handheld vacuum marination system according to disclosed embodiments;

FIG. 2 is a rear perspective view of a handheld vacuum marinator device of the handheld vacuum marination system of FIG. 1;

FIG. 3 is a front perspective view of the handheld vacuum marinator device of FIG. 2;

FIG. 4 is a perspective view of a charging cradle of the handheld vacuum marination system of FIG. 1; and

FIG. 5 is a partial view of the handheld vacuum marinator device of FIGS. 2 and 3 according to disclosed embodiments.

### DETAILED DESCRIPTION

In the following detailed description numerous specific details are set forth in order to provide a thorough understanding of the invention. However, it will be understood by those skilled in the art that the present invention can be practiced without these specific details. For example, the invention is not limited in scope to the particular type of industry application depicted in the figures. In other instances, well-known methods, procedures, and components have not been described in detail so as not to obscure the present invention.

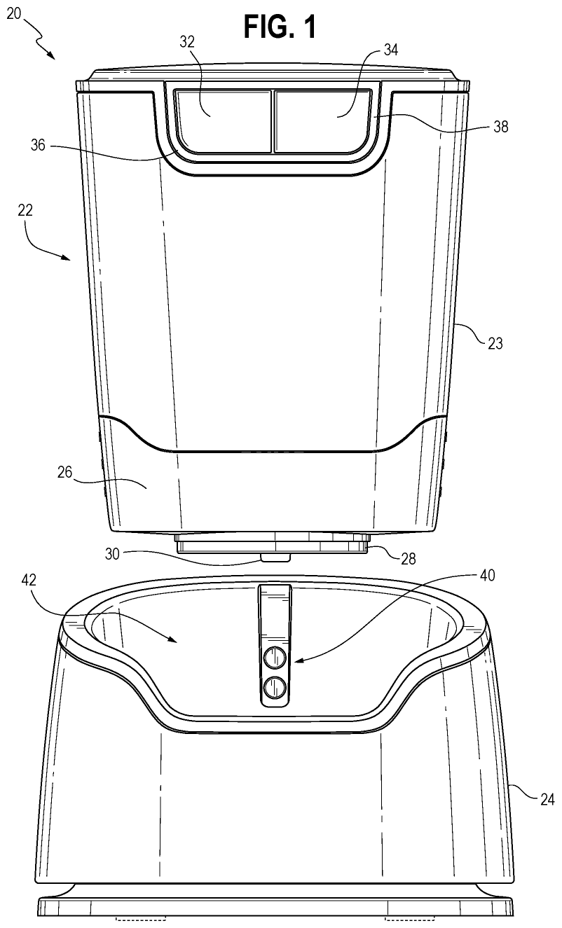

Turning first to FIG. 1, a handheld vacuum marination system 20 is illustrated. The handheld vacuum marination system 20 can include a handheld vacuum marinator device 22 encased by a housing 23. The marinator device 22 maybe selectively received in a charging cradle 24. In some embodiments, the handheld vacuum marinator device 22 can further include a a removable reservoir 26, a vacuum port or gasket 28, a suction inlet 30, a suction function button 32, a marinade function button 34, a suction function indicator 36, and a marinade function indicator 38. Furthermore, the charging cradle 24 can include electrical contacts 40 and a cavity 42 that is configured to receive at least a portion of the handheld vacuum marinator device 22.

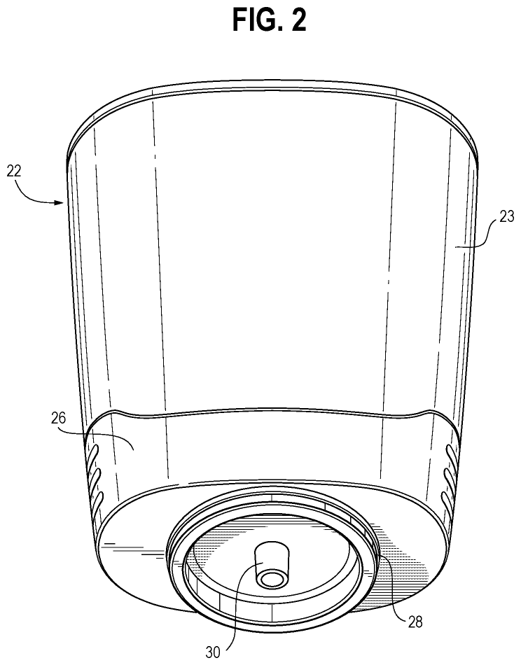

Turning to FIG. 2, a rear view of a handheld vacuum marinator device 22 is provided. The removable reservoir 26 may be removably coupled (e.g., via friction fit or snap fit or the like as would be understood) to the housing 23 over the suction inlet 30. The removable reservoir 26 may include the vacuum port or gasket 28 for sealing the housing 23 to a bag or container.

The vacuum port or gasket 28 can form an airtight seal with a vacuum port on a bag or container such that when a vacuum is drawn, air does not escape at a contact point between the vacuum port or gasket 28 and the bag or container. Furthermore, in some embodiments, when the removable reservoir 26 is coupled to the housing 23, the vacuum port or gasket 28 can surround the suction inlet 30 and can protrude outward from the housing 23 by a first distance. The first distance may be greater than a second distance by which the suction inlet 30 protrudes outward from the housing 23.

The removable reservoir 26 may further include a sealing member or O-ring positioned and located between the removable reservoir 26 and the housing 23 to form an airtight seal between the removable reservoir 26 and the housing 23. The sealing member can be permanently affixed or releasably attachable to the removable reservoir 26. In some embodiments, the removable reservoir 26 can be configured to capture any liquids that are sucked into the handheld vacuum marinator device 22 during operation. The handheld vacuum marinator device 22 can also include an outlet port or an aperture that extends through a sidewall of the housing 23 to further help prevent moisture from collecting inside the housing 23, for example when the removable reservoir 26 is filled to capacity.

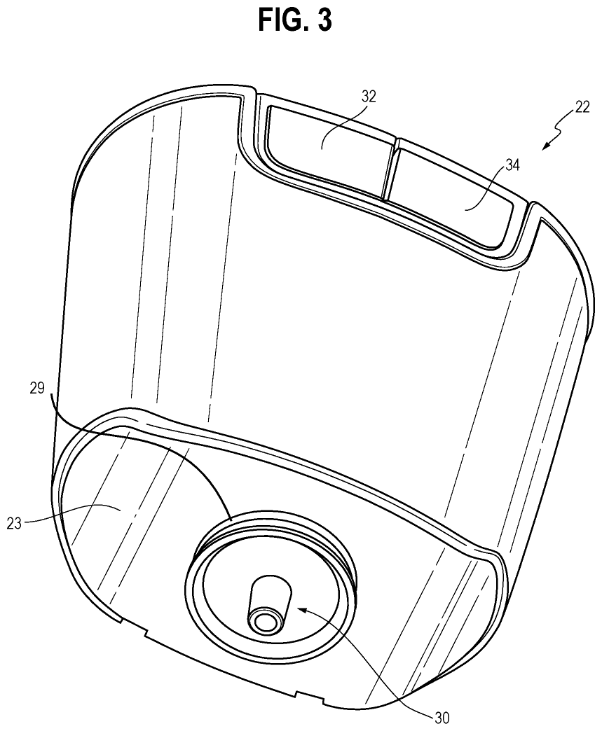

Turning to FIG. 3, a front perspective view of the handheld vacuum marinator device 22 with the removable reservoir 26 removed from the housing 23 is provided. The housing 23 can include a recessed lip 29 configured to receive an upper position of the removable reservoir 26. Furthermore, when the removable reservoir 26 is removed, the suction inlet 30 can be exposed for use as a suction port on an accessory (such as a wine stopper, canister, jar, or other accessory) to vacuum air from within a vessel, like a wine bottle. In some embodiments, the suction inlet 30 can be molded into a bottom portion of the handheld vacuum marinator device 22. However, in yet other embodiments, the suction inlet 30 can be selectively engageable with the handheld vacuum marinator device 22.

The suction inlet 30 can be used in connection with a vacuum container containing a two-way valve having a position for marinating a food product. For example, to place the container in the marinate position, a knob of the container can be rotated such that an indicator points to a “marinate” or “open” label on the two-way valve. The marinate position can allow air to flow in and out of the two-way valve via an air channel so that the marinade procedure as discussed in more detail below can be carried out.

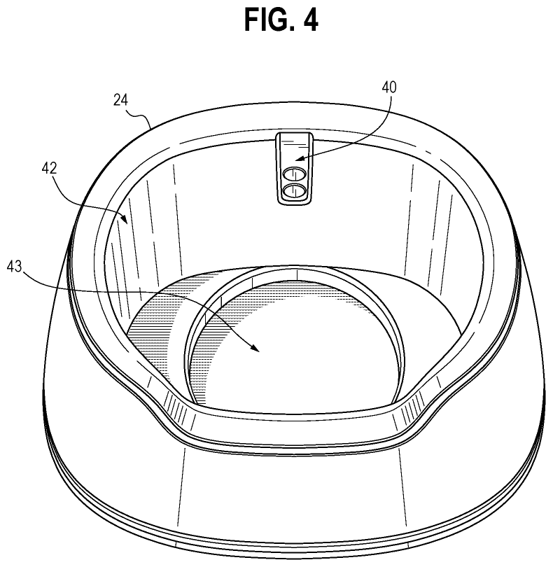

Turning to FIG. 4, a front view of a charging cradle 24 is shown. A cavity 42 of the charging cradle 24 can include a recess 43 that is sized and shaped to securely receive the vacuum port or gasket 28. In some embodiments, the cavity 42 and/or the recess 43 can also include one or more internal structures such as projections, grooves, or protrusions configured to prevent the handheld vacuum marinator device 22 from suctioning or sticking to the charging cradle 24 when engaged therewith. A cord (not illustrated) can be used to supply power to the charging cradle 24 (and subsequently the handheld vacuum marinator device 22) using known electronic methods. In these embodiments, the cord can be wrapped around charging cradle 24 and secured by one or more structures on the charging cradle 24 such as a neck portion and/or a gap within the charging cradle 24 as known in the art.

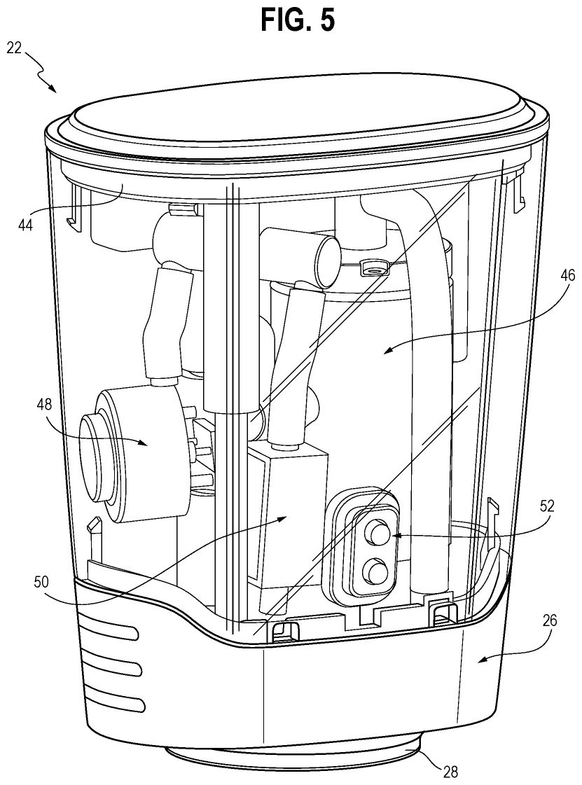

When the handheld vacuum marinator device 22 is to be charged, it can be placed in the charging cradle 24 such that charging contacts 52 on the handheld vacuum marinator device 22 (see FIG. 5) connect with the electrical contacts 40 in the charging cradle 24. In some embodiments, the electrical contacts 40 can include two circumferential electrical contacts or charger contact strips (not illustrated) that each are continuously formed to circumscribe the interior of the charging cradle 24. The electrical contacts 40 are preferably positioned and located at a height to allow the electrical contacts 40 to mate with that charging contacts 52 when the handheld vacuum marinator device 22 is placed in the charging cradle 24. In an alternative embodiment, the electrical contacts 40 can include a single strip and/or a single contact.

In some embodiments, the charging cradle 24 can include additional electrical contacts so that the handheld vacuum marinator device 22 can be inserted into the charging cradle 24 in different orientations and still be recharged. For example, in embodiments where the handheld vacuum marinator device 22 and the charging cradle have substantially square cross-sections, there can be four configurations by which the handheld vacuum marinator device 22 can be placed in the charging cradle 24 and be charged thereby. However, in alternative embodiments, for example, where the handheld vacuum marinator device 22 and the charging cradle 24 have circular cross-sections, the handheld vacuum marinator device 22 can be placed in a nearly limitless number of configurations within the charging cradle 24, and in any of those configurations, no matter how the handheld vacuum marinator device 22 is placed within the charging cradle 24, the charging contacts 52 can abut electrical contacts such as the electrical contacts 40.

Turning now to FIG. 5, a partial view of the handheld vacuum marinator device 22 is shown. The handheld vacuum marinator device 22 can include a control unit 44, a vacuum device 46, a vacuum switch or sensor 48, a release valve 50, and the charging contacts 52. In some embodiments, the release valve 50 can include a solenoid configured to open a vacuum pulled by the vacuum device 46 to atmosphere at the direction of the control unit 44. In some embodiments, the vacuum switch or sensor 48 can be positioned within the housing 23 such that it will be in fluid communication with a bag or container being used in connection with the handheld vacuum marinator device 22.

The vacuum device 46 can include a vacuum pump and a motor secured and housed within the housing 23 in several known or foreseeable ways. In some embodiments, the vacuum pump can include a rotary diaphragm pump that allows for quiet operation when the handheld vacuum marinator device 22 is activated in the manner described below. The rotary diaphragm pump, like those known and used in similar sealer devices, draws a vacuum from within the handheld vacuum marinator device 22 by moving a flexible diaphragm which forces air in through an air inlet port (not illustrated) and then out by using control valves. Additionally, other pump types known and understood in the art can be used. In some embodiments, the vacuum pump can be driven by the motor, which can include any of the types of motors known and understood in the art that are mechanically capable of operating the vacuum pump. Furthermore, the motor can be located and positioned in various location so long as the motor is in mechanical and electrical communication with the vacuum pump.

In some embodiments, the handheld vacuum marinator device 22 can include an internal power source that can be recharged by the charging cradle 24 using the electrical contacts 52. The power source can be placed with in the housing 23 in a variety of locations so long as it is in electrical communication with the vacuum device 46 and other components that require electrical power. The power source can include rechargeable Ni-MH batteries, for example three ⅓ AA Ni-MH batteries. Additional rechargeable power sources known in the art are also contemplated.

As discussed above, the charging contacts 52 can be used to charge the power source for the handheld vacuum marinator device 22 in conjunction with the charging cradle 24. Various embodiments for the charging contacts 52 are known in the art. For example, the charging contacts 52 can be included with a charge port on the housing 23. The charge port can include a socket cover located and positioned on a sidewall of the housing 23, for example partially recessed, fully recessed, or projecting out from the sidewall. In these embodiments, the socket cover can include a first socket cover section and a second socket cover section that has a smaller area than the first socket cover section and that projects away from the first socket cover section. The second socket cover section can also include a limit rib that extends across the width of the second socket cover section and that keeps the charging contacts 52 engaged with the electrical contacts 40 of the charging cradle 24. In some embodiments, the charge port can include at least one charging contact aperture through which the charging contacts 52 can extend so as to pass through both the first socket cover section and the second socket cover section.

The control unit 44 can be embedded on a printed circuit board or otherwise arranged within the housing 23. The control unit 44 and printed circuit board can include resistors, controllers, micro-controllers, and other electronic and data components that can be required to operate and/or control the handheld vacuum marinator device 22. In some embodiments the control unit 44 can be in electrical and/or mechanical communication with the electronic and mechanical components used to operate the handheld vacuum marinator device 22 such as the vacuum device 46, the suction function button 32, the marinade function button 34, the suction function indicator 36, the marinade function indicator 38, the vacuum switch or sensor 48, and the release valve 50.

In operation, the control unit 44, in response to detecting activation of the suction function button 32, can automatically activate a suction procedure used to remove air from within a container or bag in order to preserve freshness of food to be stored within the container, or bag, as known in the art. Furthermore, the control unit 44 can activate an automatic vacuum marinade procedure in response to detecting activation of the marinade function button 34. Various embodiments for the suction function button 32 and the marinade function button 34 are contemplated. For example, in some embodiments, the suction function button 32 and the marinade function button 34 can include easily depressed mechanical spring switches.

In some embodiments, the suction procedure can include activating the vacuum device 46 to pull the vacuum through the suction inlet 30 including any bag or container attached thereto and then deactivating the vacuum device 46 when the vacuum switch or sensor 48 detects a first vacuum level. In some embodiments, the first vacuum level can be at or around −10″Hg. Additionally or alternatively, in some embodiments, the suction procedure can include activating the vacuum device 46 to pull the vacuum through the suction inlet 30 so long as the suction function button 32 is being depressed. In some embodiments, the suction function button 32 can be omitted and the suction procedure can be activated by pressing and holding the marinade function button 34.

Furthermore, in some embodiments, the marinade procedure can include automatically initiating a plurality of cycles of activating the vacuum device 46 to pull the vacuum through the suction inlet 30, deactivating the vacuum device 46 when the vacuum switch or sensor 48 detects a second vacuum level, holding the second vacuum level for a first preset amount of time, activating the release valve 50 to release the vacuum after the first preset amount of time, and waiting a second preset amount of time to reactivate the vacuum device 46 for a start of a next one of the plurality of cycles. In some embodiments, the second vacuum level can also be at or around −10″Hg. However other embodiments, where the first and second vacuum levels are different values and/or are different from each other are also contemplated. In some embodiments, the first and second preset amounts of time can be modified via a remote user interface connected to the control unit 44 via wired or wireless connections known in the art.

In some embodiments, the control unit 44 can activate the suction function indicator 36 to indicate that the suction procedure is being performed and can activate the marinade function indicator 38 to indicate that the marinade procedure is being performed. In some embodiments, the suction function indicator 36 can include a first LED (light emitting diode) light pipe proximate to the suction function button 32 and the marinade function indicator 38 can include a second LED light pipe proximate to the marinade function button 34. In these embodiments, the control unit 44 can pulse the second LED light pipe on and off during the marinade procedure before turning on the second LED light pipe for a third preset amount of time when the plurality of cycles are completed.

Furthermore, in some embodiments, the suction function indicator 36 and/or the marinade function indicator 38 can signal when the handheld vacuum marinator device 22 has been placed in the charging cradle 24 such that and the handheld vacuum marinator device 22 is currently being charged thereby. the suction function indicator 36 and/or the marinade function indicator 38 can further signal that the handheld vacuum marinator device 22 has low power or has been fully charged.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

What is claimed is:

1. A handheld vacuum marinator device comprising:
a housing containing a vacuum device and a suction inlet fluidly coupled to the vacuum device;
a removable reservoir configured to couple to the housing over the suction inlet and including a gasket for sealing the housing to a bag or container;
a suction function button on or embedded in the housing and configured to activate a suction procedure when depressed; and
a marinade function button on or embedded in the housing and configured to activate a marinade procedure when depressed,
wherein the suction procedure includes activating the vacuum device to pull a vacuum through the suction inlet and deactivating the vacuum device when a first vacuum level is detected, and
wherein the marinade procedure includes initiating a plurality of cycles of activating the vacuum device to pull the vacuum through the suction inlet, deactivating the vacuum device when a second vacuum level is detected, holding the second vacuum level for a first preset amount of time, releasing the vacuum after the first preset amount of time, and waiting a second preset amount of time to reactivate the vacuum device for a start of a next one of the plurality of cycles.

2. The handheld vacuum marinator device of claim 1 wherein the vacuum device includes a vacuum pump and a motor configured to drive the vacuum pump.

3. The handheld vacuum marinator device of claim 1 further comprising:
a suction function indicator that activates when the suction procedure is occurring; and
a marinade function indicator that activates when the marinade procedure is occurring.

4. The handheld vacuum marinator device of claim 3 wherein the suction function indicator includes a first LED light pipe proximate to the suction function button, and wherein the marinade function indicator includes a second LED light pipe proximate to the marinade function button.

5. The handheld vacuum marinator device of claim 4 wherein the second LED light pipe pulses on and off during the marinade procedure before turning on for a third preset amount of time when the plurality of cycles are completed.

6. The handheld vacuum marinator device of claim 1 further comprising a microcontroller embedded on a printed circuit board and electrically coupled to the vacuum device, the suction function button, and the marinade function button, and wherein the microcontroller activates the suction procedure and the marinade procedure in response to detecting depression of the suction function button and the marinade function button, respectively.

7. The handheld vacuum marinator device of claim 1 further comprising a vacuum switch in fluid connection with the suction inlet that detect the first vacuum level and the second vacuum level.

8. The handheld vacuum marinator device of claim 7 wherein the first vacuum level is equal to the second vacuum level.

9. The handheld vacuum marinator device of claim 7 wherein the first vacuum level is different from the second vacuum level.

10. The handheld vacuum marinator device of claim 1 further comprising a release valve configured to open the vacuum to atmosphere after expiration of the first preset amount of time.

11. A handheld vacuum marination system comprising:
a handheld vacuum marinator device comprising:
a housing containing a vacuum device and a suction inlet fluidly coupled to the vacuum device;
a removable reservoir removably coupled to the housing over the suction inlet;
a suction function button on or embedded in the housing and configured to activate a suction procedure when depressed; and
a marinade function button on or embedded in the housing and configured to activate a marinade procedure when depressed; and
a charging cradle configured to receive the handheld vacuum marinator device.

12. The system of claim 11, wherein the suction procedure includes activating the vacuum device to pull a vacuum through the suction inlet and deactivating the vacuum device when a first vacuum level is detected.

13. The system of claim 12, wherein the marinade procedure includes initiating a plurality of cycles of activating the vacuum device to pull the vacuum through the suction inlet, deactivating the vacuum device when a second vacuum level is detected, holding the second vacuum level for a first preset amount of time, releasing the vacuum after the first preset amount of time, and waiting a second preset amount of time to reactivate the vacuum device for a start of a next one of the plurality of cycles.

14. The system of claim 11, wherein the vacuum device includes a vacuum pump and a motor configured to drive the vacuum pump.

15. The system of claim 13, further comprising:
a suction function indicator that activates when the suction procedure is occurring; and
a marinade function indicator that activates when the marinade procedure is occurring.

16. The system of claim 13, further comprising a microcontroller embedded on a printed circuit board and electrically coupled to the vacuum device, the suction function button, and the marinade function button, and wherein the microcontroller activates the suction procedure and the marinade procedure in response to detecting depression of the suction function button and the marinade function button, respectively.

17. The system of claim 13, further comprising a vacuum switch in fluid connection with the suction inlet that detects the first vacuum level and the second vacuum level.

18. The system of claim 17, wherein the first vacuum level is equal to the second vacuum level.

19. The system of claim 17, wherein the first vacuum level is different from the second vacuum level.

20. The system of claim 11, wherein the charging cradle contains electrical contacts and the handheld vacuum marinator device contains charging contacts, such that when the handheld vacuum marinator device is received within the charging cradle, the electrical contacts contact the charging contacts.
